(19) United States
(12) Patent Application Publication
(10) Pub. No.: US 2013/0300625 A1
(43) Pub. Date: Nov. 14, 2013

(54) COMMUNICATION DEVICE AND MIMO (MULTI-INPUT MULTI-OUTPUT) ANTENNA SYSTEM THEREIN

(71) Applicants: Kin-Lu WONG, Kaohsiung City (TW); Tsung-Ju WU, Kaohsiung City (TW)

(72) Inventors: Kin-Lu WONG, Kaohsiung City (TW); Tsung-Ju WU, Kaohsiung City (TW)

(73) Assignee: ACER INCORPORATED, Taipei Hsien (TW)

(21) Appl. No.: 13/557,708

(22) Filed: Jul. 25, 2012

(30) Foreign Application Priority Data
May 11, 2012 (TW) 101116785

(51) Int. Cl. H01Q 1/48

(52) U.S. Cl. 343/848

(57) ABSTRACT

A communication device including a ground plane and an antenna system is provided. The antenna system includes at least two antennas, which are both located at a first edge of the ground plane and operate in at least a first band. The ground plane has at least one slit, and an open end of the slit is located at a second edge adjacent to the first edge. The open end of the slit has a distance of at least 0.2 wavelength of a frequency in the first band to the first edge. When the antenna system operates in the first band, the slit can attract excited surface currents on the ground plane, thereby causing weaker surface currents flowing along the first edge of the ground plane. The coupling between the at least two antennas in the antenna system is hence decreased.

### CROSS REFERENCE TO RELATED APPLICATIONS

This application claims priority of Taiwan Patent Application No. 101116785 filed on May 11, 2012, the entirety of which is incorporated by reference herein.

### BACKGROUND OF THE INVENTION

1. Field of the Invention

The disclosure generally relates to a communication device, and more particularly, relates to a communication device comprising a MIMO (Multi-Input and Multi-Output) antenna system with high isolation.

2. Description of the Related Art

As people demand more and more data transmission, related communication standards are supporting higher and higher data transmission rates. For example, IEEE 802.11n can support MIMO technology to increase transmission rates. The related communication standards, such as LTE (Long Term Evolution), also support MIMO operations. As a matter of fact, it is a future trend to use multiple antennas in a mobile device. However, since multiple antennas are to be disposed in a limited space of a mobile device, the isolation between these antennas will be an important factor to be considered.

Traditionally, the method for improving isolation and for reducing mutual coupling between MIMO antennas is to dispose an isolation element between two adjacent antennas, wherein the resonant frequency of the isolation element is approximately equal to that of the antennas so as to decrease the mutual coupling between the antennas. The drawbacks of the traditional method include decreased antenna efficiency and degraded radiation performance. In addition, if these antennas are operated in an LTE700 band (from 704 MHz to 787 MHz), the isolation element is required to become resonance at about 700 MHz and hence requires a large element size, which greatly increases the size of the whole antenna system. Integration of such an antenna system in the limited space inside the mobile device is a challenge for an antenna designer.

Accordingly, there is a need to provide a new communication device which performs MIMO operations without any isolation element but has good isolation. The antenna efficiency of the antenna system in the communication device should not be affected, or should even be enhanced.

### BRIEF SUMMARY OF THE INVENTION

The invention is aimed to provide a communication device comprising an antenna system. The antenna system comprises at least two antennas and is located at an edge of a ground plane. The communication device of the invention has high isolation without any isolation element between the antennas in the antenna system, and the antenna efficiency is generally maintained.

In an embodiment, the disclosure is directed to a communication device, comprising: a ground plane, having a first edge and a second edge, wherein the first edge and the second edge are adjacent edges of the ground plane; and an antenna system, comprising at least a first antenna and a second antenna, wherein the first antenna and the second antenna are both located at the first edge, each of the first antenna and the second antenna operates in at least a first band, and a plane on which the first antenna and the second antenna are disposed is substantially parallel to the ground plane, wherein a length of the first edge of the ground plane is greater than or equal to 0.3 wavelength of a first frequency in the first band, the ground plane has at least one slit, the slit has an open end located at the second edge, and a distance between the open end of the slit and the first edge of the ground plane is greater than or equal to 0.2 wavelength of a second frequency in the first band. Note that when the antenna system operates in the first band, the slit attracts surface currents on the ground plane, and causes the surface currents which flow along the first edge of the ground plane to be reduced such that the coupling between the first antenna and the second antenna is decreased. Accordingly, the invention can effectively improve the isolation between the first antenna and the second antenna.

In an embodiment, the length of the slit is approximately equal to 0.25 wavelength of a frequency in the first band, and the distance between the open end of the slit and the first edge of the ground plane is greater than or equal to 0.2 wavelength of the second frequency in the first band. Furthermore, the slit is substantially parallel to the first edge and has a projection on the first edge, wherein the projection covers the first antenna. Under the circumstance, the slit can effectively attract surface currents on the ground plane, thereby reducing the surface currents which flow along the first edge of the ground plane. Since the surface currents which flow along the first edge of the ground plane significantly cause some coupling between two antennas, the presence of the slit can hence improve the isolation between the antennas. In addition, the slit generally does not affect the radiation performances of the first antenna and the second antenna, and the first antenna and the second antenna can maintain good antenna efficiency. In an embodiment, the distance between the open end of the slit and the first edge of the ground plane is smaller than 0.45 wavelength of a frequency in the first band.

In an embodiment, the isolation of the antenna system in the first band may be improved by 7 dB or more, to be about −20 dB (S21), but the radiation efficiency of the antenna system generally does not vary.

### BRIEF DESCRIPTION OF DRAWINGS

The invention can be more fully understood by reading the subsequent detailed description and examples with references made to the accompanying drawings, wherein:

FIG. 1 is a diagram for illustrating a communication device according to a first embodiment;

FIG. 2A is a diagram for illustrating S parameters of the communication device according to the first embodiment;

FIG. 2B is a diagram for illustrating S parameters of the communication device in the first embodiment but without a first slit and a second slit;

FIG. 3 is a diagram for illustrating a communication device according to a second embodiment;

FIG. 4 is a diagram for illustrating a communication device according to a third embodiment; and

FIG. 5 is a diagram for illustrating a communication device according to a fourth embodiment.

### DETAILED DESCRIPTION OF THE INVENTION

In order to illustrate the foregoing and other purposes, features and advantages of the invention, the embodiments and figures thereof in the invention are shown in detail as follows.

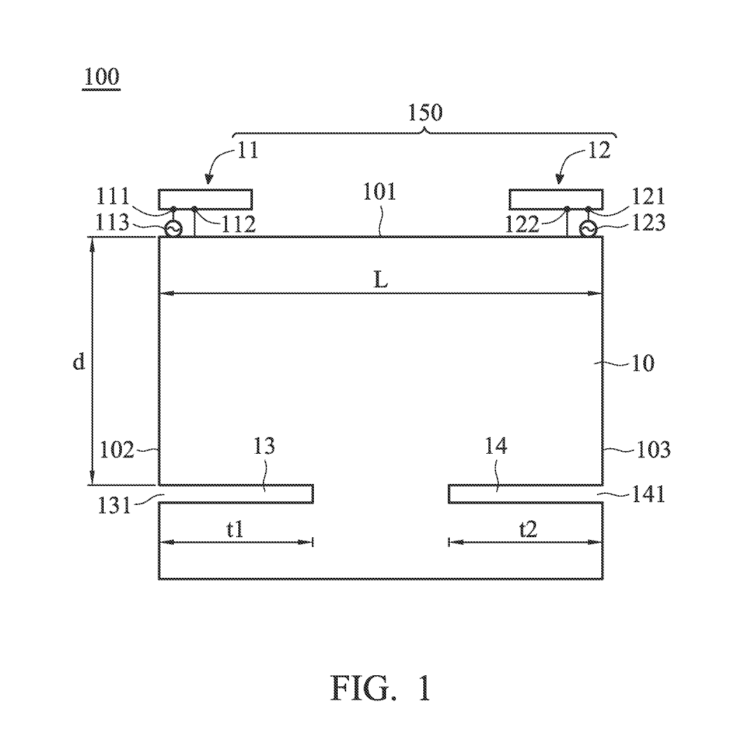

FIG. 1 is a diagram for illustrating a communication device 100 according to a first embodiment. In the embodiment, the communication device 100 comprises a ground plane 10 and an antenna system 150. The ground plane 10 has a first edge 101, a second edge 102, and a third edge 103, wherein the second edge 102 and the third edge 103 are both adjacent to the first edge 101. The antenna system 150 comprises at least a first antenna 11 and a second antenna 12. The first antenna 11 has a feeding end 111 and a shorted end 112. A signal source 113 is configured as a feeding signal source of the first antenna 11, and the signal source 113 is electrically coupled to the feeding end 111. The shorted end 112 is electrically coupled to the ground plane 10. Similarly, the second antenna 12 has a feeding end 121 and a shorted end 122. A signal source 123 is configured as a feeding signal source of the second antenna 12, and the signal source 123 is electrically coupled to the feeding end 121. The shorted end 122 is electrically coupled to the ground plane 10. The first antenna 11 and the second antenna 12 of the antenna system 150 are both substantially located at the first edge 101 of the ground plane 10. The plane on which the first antenna 11 and the second antenna 12 are disposed is substantially parallel to the ground plane 10 and extends outwardly. Each of the first antenna 11 and the second antenna 12 operates in at least a first band. The length L of the first edge 101 of the ground plane 10 is greater than or equal to 0.3 wavelength of a first frequency in the first band. The first antenna 11 and the second antenna 12 are substantially close to two opposite corners of the first edge 101, respectively. In an embodiment, the ground plane 10 may be a conductive supporting plate of the communication device 100 (e.g., a notebook computer). The ground plane 10 may have a first slit 13 and a second slit 14. The first slit 13 has an open end 131 located at the second edge 102 of the ground plane 10, and the second slit 14 has an open end 141 located at the third edge 103 of the ground plane 10. The distance d between the open end 131 of the first slit 13 and the first edge 101 of the ground plane 10 is greater than or equal to 0.2 wavelength of a second frequency in the first band. Similarly, the distance d between the open end 141 of the second slit 14 and the first edge 101 of the ground plane 10 is greater than or equal to 0.2 wavelength of the second frequency in the first band.

In some embodiments, the foregoing distance d is smaller than 0.45 wavelength of a frequency in the first band.

In some embodiments, the length t1 of the first slit 13 and the length t2 of the second slit 14 are both approximately equal to 0.25 wavelength of a frequency in the first band.

In some embodiments, both the first slit 13 and the second slit 14 are substantially parallel to the first edge 101 of the ground plane 10. The first slit 13 has a projection on the first edge 101 of the ground plane 10, and the projection covers the first antenna 11. The second slit 14 has another projection on the first edge 101 of the ground plane 10, and the projection covers the second antenna 12.

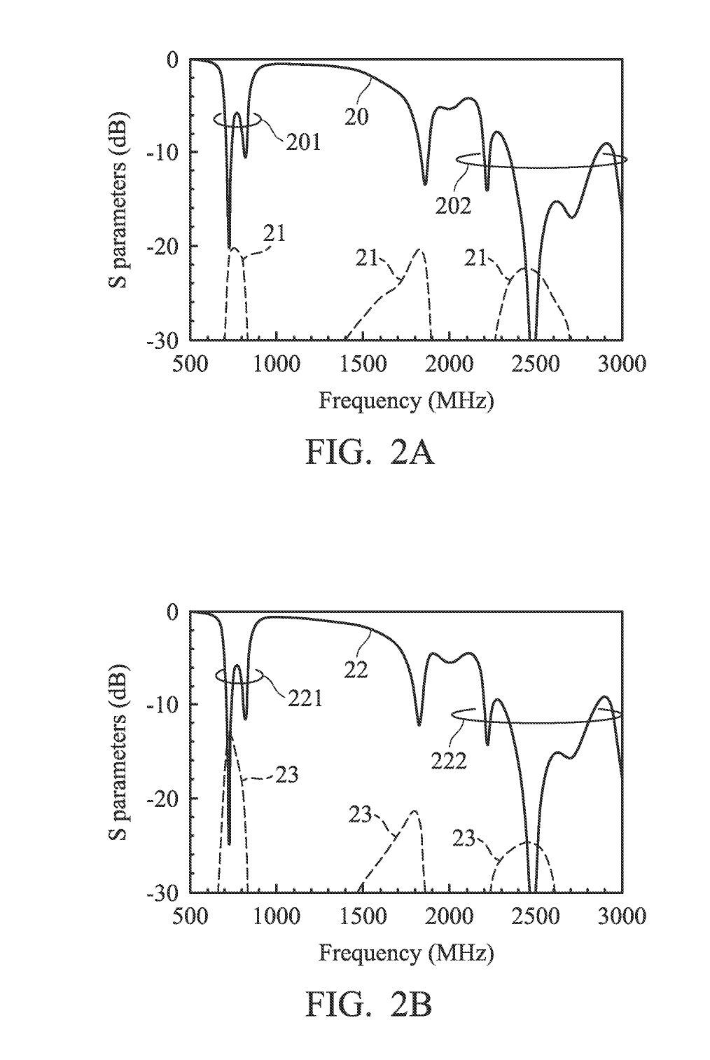

FIG. 2A is a diagram for illustrating S parameters of the communication device 100 according to the first embodiment. In the embodiment, the ground plane 10 is a conductive supporting plate of an upper cover of a notebook computer. The length L of the conductive supporting plate is approximately equal to 260 mm. The length t1 of the first slit 13 and the length t2 of the second slit 14 are both approximately equal to 90 mm. The distance d between each slit and the first edge 101 is approximately equal to 150 mm. According to the criterion of 6 dB return loss (design specification widely used for the internal antennas in mobile communication devices), the reflection coefficient (S11) curve 20 of the first antenna 11 of the antenna system 150 comprises a first band 201 and a second band 202. In a preferred embodiment, the first band 201 covers the LTE700 band (about from 704 MHz to 787 MHz), and the second band 202 covers the LTE2300/2500 bands (about from 2300 MHz to 2400 MHz and from 2500 MHz to 2690 MHz). The reflection coefficient (S22) curve of the second antenna 12 of the antenna system 150 is similar to the reflection coefficient (S11) curve 20 of the first antenna 11, and comprises at least the first band 201 and the second band 202. The reflection coefficient (S22) curve of the second antenna 12 will not be described again here. As shown in FIG. 2A, the antenna system 150 in the first embodiment can be applied to MIMO operations of an LTE system, and the isolation (S21) curve 21 which represents the isolation (S21) between the first antenna 11 and the second antenna 12 is lower than −20 dB for frequencies over the operating bands.

FIG. 2B is a diagram for illustrating S parameters of the communication device 100 in the first embodiment but without the first slit 13 and the second slit 14. According to the criterion of 6 dB return loss, the reflection coefficient (S11) curve 22 of the first antenna 11 of the antenna system 150 also comprises a first band 221 and a second band 222. The reflection coefficient (S22) curve of the second antenna 12 of the antenna system 150 is similar to the reflection coefficient (S11) curve 22 of the first antenna 11, and comprises at least the first band 221 and the second band 222. The reflection coefficient (S22) curve of the second antenna 12 will not be described again here. As shown in FIG. 2B, if the first slit 13 and the second slit 14 are not embedded in the ground plane 10, the antenna system 150 will have the isolation (S21) curve 23 of about −13 dB in the first band 221. In comparison to FIG. 2A, the invention has one or more slits formed in the ground plane 10 and improves the isolation of the antenna system 150 by 7 dB or more. Note that in the first embodiment, the isolation (S21) in the first band 201 and the second band 202 is smaller than −20 dB, and the antenna efficiency of the first antenna 11 and the second antenna 12 is approximately from 40% to 60% in the first band 201 and approximately from 60% to 90% in the second band 202 (the antenna efficiency includes the mismatching losses). The antenna efficiency in the first band 201 of the invention is higher than the antenna efficiency in the first band 221 of FIG. 2B, which has no slit in the ground plane 10.

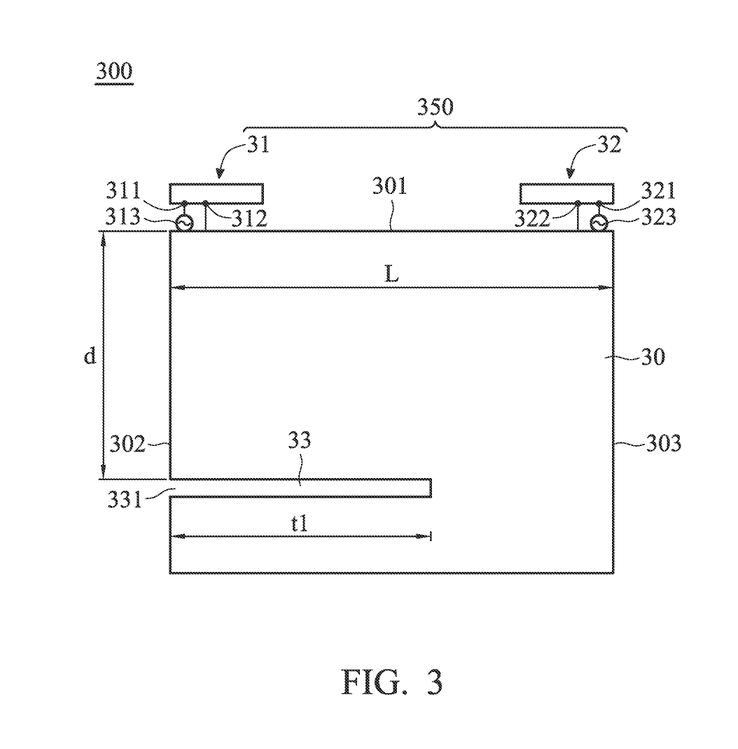

FIG. 3 is a diagram for illustrating a communication device 300 according to a second embodiment. The communication device 300 in the second embodiment is similar to that in the first embodiment. The difference between them is that a ground plane 30 of the communication device 300 has only a single first slit 33. The first slit 33 has an open end 331 located at a second edge 302 of the ground plane 30. An antenna system 350 comprises at least a first antenna 31 and a second antenna 32. The first antenna 31 has a feeding end 311 and a shorted end 312. A signal source 313 is configured as a feeding signal source of the first antenna 31, and the signal source 313 is electrically coupled to the feeding end 311. Similarly, the second antenna 32 has a feeding end 321 and a shorted end 322. A signal source 323 is configured as a feeding signal source of the second antenna 32, and the signal source 323 is electrically coupled to the feeding end 321.

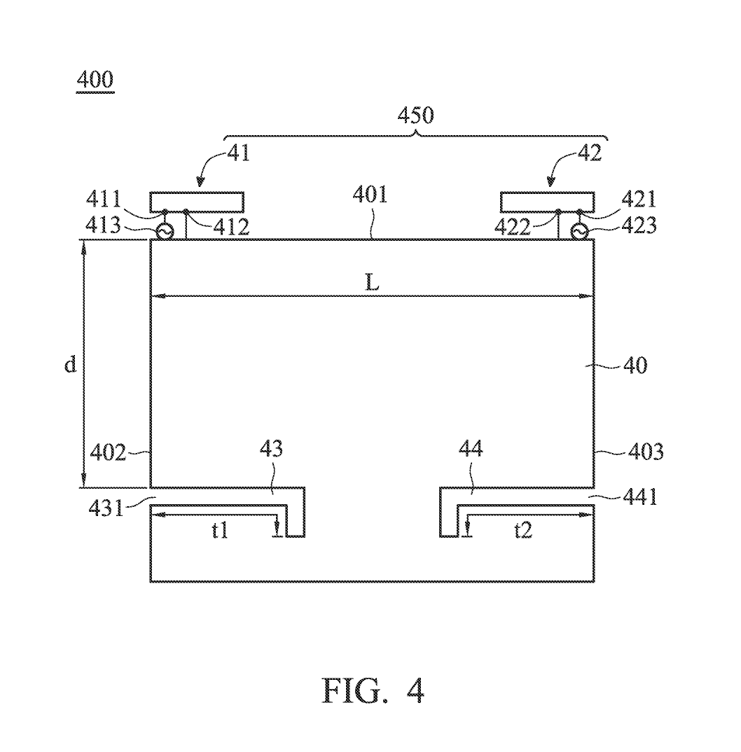

FIG. 4 is a diagram for illustrating a communication device 400 according to a third embodiment. The communication device 400 in the third embodiment is similar to that in the first embodiment. The difference between them is that a ground plane 40 of the communication device 400 has a first slit 43 and a second slit 44, and each of the first slit 43 and the second slit 44 further has a bending portion at one end. The first slit 43 has an open end 431 located at a second edge 402 of the ground plane 40, and the second slit 44 has an open end 441 located at a third edge 403 of the ground plane 40. An antenna system 450 comprises at least a first antenna 41 and a second antenna 42. The first antenna 41 has a feeding end 411 and a shorted end 412. A signal source 413 is configured as a feeding signal source of the first antenna 41, and the signal source 413 is electrically coupled to the feeding end 411. Similarly, the second antenna 42 has a feeding end 421 and a shorted end 422. A signal source 423 is configured as a feeding signal source of the second antenna 42, and the signal source 423 is electrically coupled to the feeding end 421.

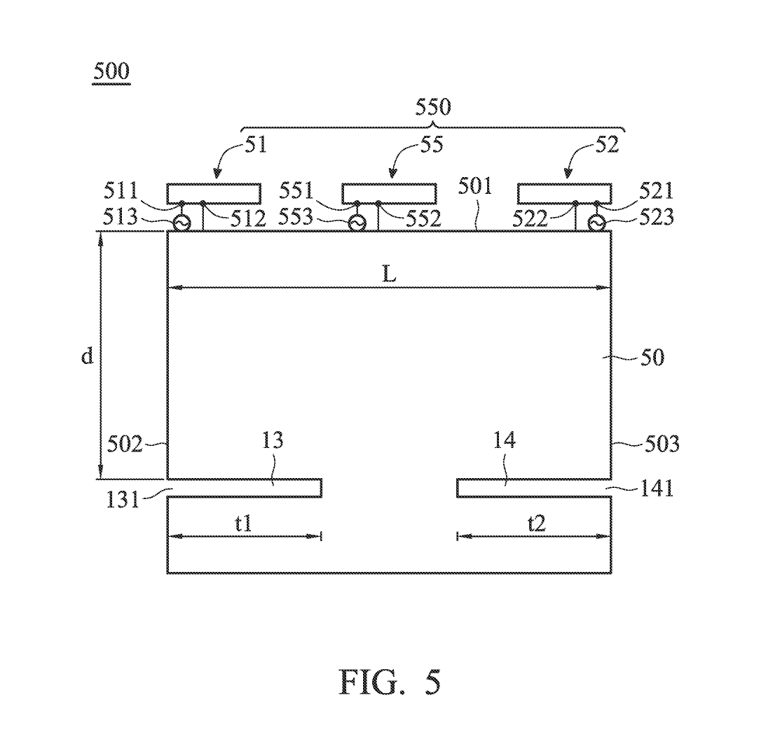

FIG. 5 is a diagram for illustrating a communication device 500 according to a fourth embodiment. The communication device 500 in the fourth embodiment is similar to that in the first embodiment. The difference between them is that an antenna system 550 of the communication device 500 further comprises a third antenna 55. A first antenna 51, a second antenna 52, and the third antenna 55 are all located at a first edge 501 of a ground plane 50. The first antenna 51 has a feeding end 511 and a shorted end 512. A signal source 513 is configured as a feeding signal source of the first antenna 51, and the signal source 513 is electrically coupled to the feeding end 511. The second antenna 52 has a feeding end 521 and a shorted end 522. A signal source 523 is configured as a feeding signal source of the second antenna 52, and the signal source 523 is electrically coupled to the feeding end 521. Similarly, the third antenna 55 has a feeding end 551 and a shorted end 552. A signal source 553 is configured as a feeding signal source of the third antenna 55, and the signal source 553 is electrically coupled to the feeding end 551.

For the invention, the communication device 300 in the second embodiment, the communication device 400 in the third embodiment, and the communication device 500 in the fourth embodiment are all similar to the communication device 100 in the first embodiment. Accordingly, the performance of the second, third, and fourth embodiments is similar to that of the first embodiment.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A communication device, comprising:
a ground plane, having a first edge and a second edge, wherein the first edge and the second edge are adjacent edges of the ground plane; and
an antenna system, comprising at least a first antenna and a second antenna, wherein the first antenna and the second antenna are both located at the first edge of the ground plane, each of the first antenna and the second antenna operates in at least a first band, and a plane on which the first antenna and the second antenna are disposed is substantially parallel to the ground plane;
wherein a length of the first edge of the ground plane is greater than or equal to 0.3 wavelength of a first frequency in the first band, the ground plane comprises at least one slit, the slit comprises an open end located at the second edge of the ground plane, and a distance between the open end of the slit and the first edge of the ground plane is greater than or equal to 0.2 wavelength of a second frequency in the first band.

2. The communication system as claimed in claim 1, wherein the distance between the open end of the slit and the first edge of the ground plane is smaller than 0.45 wavelength of a frequency in the first band.

3. The communication system as claimed in claim 1, wherein a length of the slit is approximately equal to 0.25 wavelength of a frequency in the first band.

4. The communication system as claimed in claim 1, wherein the slit is substantially parallel to the first edge and has a projection on the first edge, and the projection covers the first antenna or the second antenna.

5. The communication system as claimed in claim 1, wherein the ground plane is a conductive supporting plate.

6. The communication system as claimed in claim 1, wherein the first antenna and the second antenna are substantially close to two opposite corners of the first edge respectively.

7. The communication system as claimed in claim 1, wherein each of the first antenna and the second antenna further comprises a shorted end coupled to the ground plane.

8. The communication system as claimed in claim 1, wherein when the antenna system operates in the first band, the slit causes surface currents along the first edge of the ground plane to be reduced such that coupling between the first antenna and the second antenna is decreased.

9. The communication system as claimed in claim 1, wherein the antenna system further operates in a second band which is higher than the first band.

10. The communication system as claimed in claim 9, wherein the first band is approximately from 704 MHz to 787 MHz, and the second band is approximately from 2300 MHz to 2400 MHz and from 2500 MHz to 2690 MHz.

11. The communication system as claimed in claim 1, wherein the slit comprises at least one bend.

12. The communication system as claimed in claim 1, wherein the ground plane comprises a first slit and a second slit, the first slit comprises an open end located at the second edge of the ground plane, the second slit comprises an open end located at a third edge of the ground plane, and the third edge is opposite to the second edge.

13. The communication system as claimed in claim 12, wherein a distance between the open end of the first slit and the first edge of the ground plane is greater than or equal to 0.2 wavelength of a second frequency in the first band.

14. The communication system as claimed in claim 12, wherein a distance between the open end of the second slit and the first edge of the ground plane is greater than or equal to 0.2 wavelength of a second frequency in the first band.

15. The communication system as claimed in claim 1, wherein the antenna system further comprises a third antenna located at the first edge of the ground plane.
